(19) United States
(12) Patent Application Publication
(10) Pub. No.: US 2015/0199609 A1
(43) Pub. Date: Jul. 16, 2015

(54) SELF-LEARNING SYSTEM FOR DETERMINING THE SENTIMENT CONVEYED BY AN INPUT TEXT

(71) Applicant: XURMO TECHNOLOGIES PVT. LTD, BANGALORE (IN)

(72) Inventors: VINAY GURURAJA RAO, BANGALORE (IN); ANKIT PATIL, BANGALORE (IN); SAURABH SANTHOSH,, BANGALORE (IN); POOVIAH BALLACHANDA AYAPPA, BANGALORE (IN)

(21) Appl. No.: 14/572,863

(22) Filed: Dec. 17, 2014

(30) Foreign Application Priority Data
Dec. 20, 2013 (IN) 5981/CHE/2013

(51) Int. Cl. G06N 5/04; G06N 99/00

(52) U.S. Cl. CPC G06N 5/04; G06N 99/005

(57) ABSTRACT

A self learning system and a method for analyzing the sentiments conveyed by an input text have been disclosed. The system includes a generator that generates an initial training set comprising a plurality of words linked to corresponding sentiments. The words and corresponding sentiments are stored in a repository. A rule based classifier segregates the input text into individual words, and compares the words with the entries in the repository, and subsequently determines a first score corresponding to the input text. The input text is also provided to a machine-learning based classifier that generates a plurality of features corresponding to the input text and subsequently generates a second score corresponding to the input text. The first score and the second score are further aggregated by an ensemble classifier which further generates a classification score indicative of the sentiment conveyed by the input text.

### BACKGROUND

1. Technical Field

The present disclosure generally relates to data processing. Particularly, the present disclosure relates to electronic data processing.

2. Description of the Related Art

The Internet includes information on various subjects. This information could have been provided by experts in a particular field or casual users (for example, bloggers, reviewers, and the like). Search engines allow users to identify documents having information on various subjects of interest. However, it is difficult to accurately identify the sentiment expressed by users in respect of particular subjects (for example, the quality of food at a particular restaurant or the quality of music system in a particular automobile).

Furthermore, many reviews (or social media or blog content) are long and contain only limited amount of opinion bearing sentences. This makes it hard for a potential customer or service provider to make an informed decision based on the social media content. Accordingly, it is desirable to provide a summarization technique, which provides opinion bearing information about different categories of a selected product, or hotel, or service.

Sentiment analysis techniques can be used to assign a piece of text a single value that represents opinion expressed in that text. One problem with existing sentiment analysis techniques is that when the text being evaluated expresses two independent opinions, the sentiment analysis technique is rendered inaccurate. Another problem with the existing sentiment analysis techniques is that they require extensive rules to ensure an analysis. Yet another problem with the existing sentiment analysis is that they implement machine learning techniques that require a voluminous initial training set. Another problem with existing sentiment analysis techniques is that the sentiment options are not flexible. Yet another problem with the existing sentiment analysis techniques is that, these techniques fails to identify sentiment at any level of text granularity i.e. at a word, sentence, paragraph or document level. Yet another problem with the existing sentiment analysis techniques is that, these techniques are not self-learning. For at least the aforementioned reasons, improvements in the sentiment analysis techniques are desirable and necessary.

Hence, there was felt a need for a method and system for analyzing the input text in to identify the sentiment conveyed therefrom. Further, there was felt a need for a self-learning method and system which uses an ensemble of rule based approach and machine learning based approach to analyze the sentiment conveyed from an input text.

### OBJECTS

The primary object of the present disclosure is to provide a method and system for analyzing the sentiment conveyed by a voluminous text.

Another object of the present disclosure is to provide a method and system for providing sentiment of different kinds and at different scales as per the user requirements (for example, Positive and Negative sentiment or Bullish and Bearish sentiment or Euphoric, Happy, Neutral, Sad and Depressed sentiment).

Yet another object of the present disclosure is to provide a self-learning method and system for analyzing sentiment in large volumes of text in multiple languages.

Yet another object of the present disclosure is to provide a self-learning method and system for analyzing sentiment in a collection of structured, unstructured and semi-structured data that comes from the heterogeneous sources.

Yet another object of the present disclosure is to provide a self-learning method and system for analyzing sentiment using an ensemble of rule based approach and machine learning based approach.

These and other objects and advantages of the present disclosure will become apparent from the following detailed description read in conjunction with the accompanying drawings.

### SUMMARY

The present disclosure envisages a computer implemented self learning system for analyzing the sentiments conveyed by an input text. The system comprises a generator configured to generate an initial training set comprising a plurality of words, wherein each of said words is linked to a corresponding sentiment.

The system further comprises a repository communicably coupled to said generator, and configured to store each of said words and corresponding sentiments.

The system further comprises a rule based classifier cooperating with said generator and said repository, said rule based classifier configured to receive the input text and segregate the input text into a plurality of words, said rule based classifier still further configured to compare each of said plurality of words with the entries in the repository and select amongst the plurality of words, the words being semantically similar to the entries in the repository, said rule based classifier still further configured to assign a first score to only those words that match the entries of said repository, said rule based classifier further configured to aggregate the first score assigned to respective words and generate an aggregated first score.

The system further comprises a machine-learning based classifier cooperating with said generator and said repository, said machine learning based classifier configured to receive the input text and process said input text, said machine learning based classifier further configured to generate a plurality of features corresponding to the input text based on the processing of the input text, and generate a second score corresponding to the input text.

The system further comprises an ensemble classifier configured to combine the aggregated first score generated by the rule based classifier and the second score generated by the machine learning based classifier, said ensemble classifier further configured to generate a classification score denoting the sentiment conveyed by the input text.

The system further comprises a training module cooperating with said ensemble classifier, said training module further configured to receive the input text processed by said rule based classifier and said machine-learning based classifier respectively, said training module further configured to iteratively generate training sets based on said input text and output said training sets to the generator.

In accordance with the present disclosure, said rule based classifier further comprises a tokenizer module configured to divide each word of the input text into corresponding tokens.

In accordance with the present disclosure, said rule based classifier further comprises slang words handling module, said slang words handling module configured to identify the slang words present in the input text, said slang words handling module further configured to selectively expand identified slang words thereby rendering the slang words meaningful.

In accordance with the present disclosure, the rule based classifier is further configured to assign the first score to each of the words segregated from the input text, said rule based classifier further configured to refine the score assigned to each of said words based on the syntactical connectivity between each of said words and a plurality of negators and intensifiers.

In accordance with the present disclosure, said rule based classifier is configured not to assign a score to the words of the input text, for which no corresponding semantically similar entry are present in said repository.

In accordance with the present disclosure, the machine learning based classifier further comprises a feature extraction module configured to convert the input text into a plurality of n-grams of size selected from the group of sizes consisting of size 1, size 2 and size 3, said feature extraction module further configured to process each of the n-grams as individual features.

In accordance with the present disclosure, said feature extraction module is further configured to process the input text and eliminate repetitive words from the input text, said feature extraction module further configured to process and remove stop words from the input text.

In accordance with the present disclosure, said ensemble classifier is further configured to compare said aggregated first score and said second score with a predetermined threshold value, said ensemble classifier further configured to generate the classification score based on the input text corresponding to the aggregated first score, in the event that the aggregated first score is greater than the predetermined threshold value, said ensemble classifier further configured to generate the classification score based on the combination of the aggregated first score and said second score, in the event that the aggregated first score is lesser than the predetermined threshold value.

In accordance with the present disclosure, said training module is configured to generate a training set based on the input text corresponding to the aggregated first score, in the event that the aggregated first score is greater than a second predetermined threshold value, said training module further configured to generate a training set based on the combination of input text corresponding to the aggregated first score and the input text corresponding to the second score, in the event that the aggregated first score is lesser than a second predetermined threshold value.

In accordance with the present disclosure, the training module cooperates with the machine learning based classifier to selectively process the training set, said training module further configured to instruct said machine learning based classifier to selectively adapt the machine learning algorithms stored thereupon, based on the performance of said machine learning algorithms with reference to the training sets.

The present disclosure envisages a computer implemented method for analyzing the sentiments conveyed by an input text. The method, in accordance with the present disclosure comprises the following steps:
generating, using a generator, an initial training set comprising a plurality of words linked to respective sentiments;
storing each of said words and corresponding sentiments, in a repository;
receiving the input text at a rule based classifier and segregating the input text into a plurality of words;
comparing, using the rule based classifier, each of said plurality of words with the entries in the repository and selecting amongst the plurality of words, the words being semantically similar to the entries in the repository;
assigning a first score to only those words that match the entries of said repository, and aggregating the first score assigned to respective words and generating an aggregated first score;
receiving the input text at a machine learning based classifier, and processing said input text using said machine learning based classifier and generating a plurality of features corresponding to the input text:
generating, using said machine learning based classifier, a second score corresponding to the input text, based upon the features of the input text;
combining the aggregated first score generated by the rule based classifier and the second score generated by the machine learning based classifier, and generating a classification score denoting the sentiment conveyed by the input text;
receiving the input text processed by said rule based classifier and said machine-learning based classifier, at a training module, and iteratively generating a plurality of training sets based on said input text, and
selectively transmitting said training sets to the generator.

In accordance with the present disclosure, the step of segregating the input text into a plurality of words further includes the following steps:
dividing each word of the input text into corresponding tokens;
identifying the slang words present in the input text, using a slang words handling module, and selectively expanding identified slang words thereby rendering the slang words meaningful;
assigning the first score to each of the words segregated from the input text; and
selectively refining the score assigned to each of said words based on the syntactical connectivity between each of said words and a plurality of negators and intensifiers; and
not assigning a score to those words of the input text, for which no corresponding semantically similar entry are present in said repository.

In accordance with the present disclosure, the step of receiving the input text at a machine learning based classifier, and processing said input text using said machine learning based classifier, further includes the following steps:
converting the input text into a plurality of n-grams of size selected from the group of sizes consisting of size 1, size 2 and size 3, and processing each of the n-grams as individual features;
eliminating repetitive words from the input text, and removing stop words from the input text.

In accordance with the present disclosure, the step of generating a classification score denoting the sentiment conveyed by the input text, further includes the following steps:
comparing, using an ensemble classifier, said aggregated first score and said second score with a predetermined threshold value;
generating the classification score based on the input text corresponding to the aggregated first score, in the event that the aggregated first score is greater than the predetermined threshold value; and
generating the classification score based on the combination of the aggregated first score and said second score, in the event that the aggregated first score is lesser than the predetermined threshold value.

In accordance with the present disclosure, the step of iteratively generating a plurality of training sets based on said input text, further includes the following steps:
generating a training set based on the input text corresponding to the aggregated first score, in the event that the aggregated first score is greater than a second predetermined threshold value;
generating a training set based on the combination of input text corresponding to the aggregated first score and the input text corresponding to the second score, in the event that the aggregated first score is lesser than a second predetermined threshold value; and
selectively processing the training set, and instructing said machine learning based classifier to selectively adapt the machine learning algorithms stored thereupon, based on the performance of said machine learning algorithms with reference to the training sets.

### BRIEF DESCRIPTION OF THE DRAWINGS

The other objects, features and advantages will occur to those skilled in the art from the following description of the preferred embodiment and the accompanying drawings in which:

FIG. 1 is a block diagram illustrating the components of the computer implemented self-learning system for determining the sentiment conveyed by an input text, in accordance with the present disclosure;

FIG. 2 is a flow chart illustrating the steps involved in the computer implemented method for determining the sentiment conveyed by an input text, in accordance with the present disclosure;

FIG. 3 is a flow chart illustrating a routine for segregating the input text into a plurality of words, for use in the method illustrated in FIG. 2, in accordance with the present disclosure;

FIG. 4 is a flow chart illustrating a routine for receiving the input text at a machine learning based classifier and processing the input text using said machine learning based classifier, for use in the method illustrated in FIG. 2, in accordance with the present disclosure;

FIG. 5 is a flow chart illustrating a routine for generating a classification score denoting the sentiment conveyed by the input text, for use in the method illustrated in FIG. 2, in accordance with the present disclosure; and

FIG. 6 is a flow chart illustrating a routine for iteratively generating a plurality of training sets based on the input text, for use in the computer implemented method illustrated by FIG. 2, in accordance with the present disclosure.

Although the specific features of the present disclosure are shown in some drawings and not in others, this is done for convenience only as each feature may be combined with any or all of the other features in accordance with the present disclosure.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The present disclosure envisages a computer implemented, self-learning system for determining the sentiment conveyed by an input text. The system envisaged by the present disclosure is adapted to analyze/process data gathered from a plurality of sources including but not restricted to structured data sources, unstructured data sources, homogeneous and heterogeneous data sources.

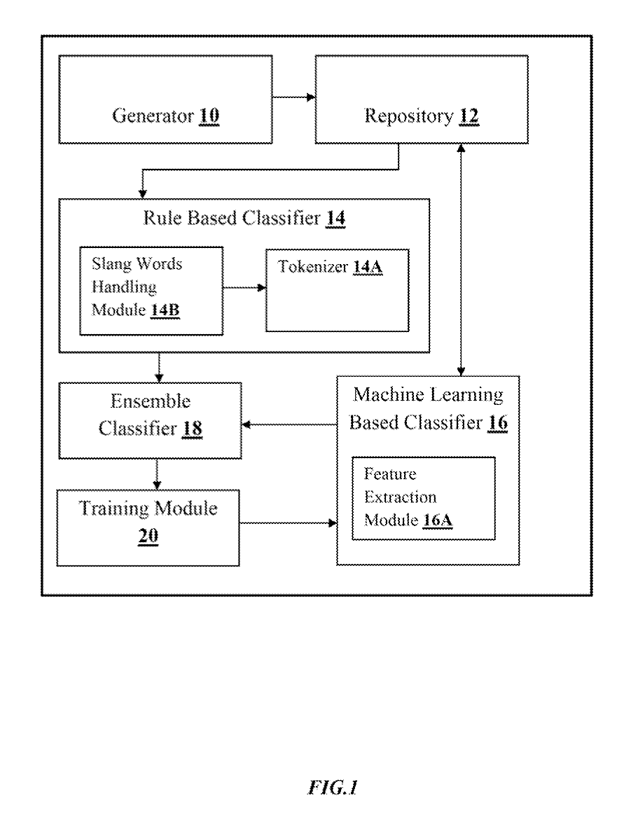

Referring to FIG. 1 of the accompanying drawings, there is shown a computer implemented, self-learning system 100 for determining the sentiment conveyed by an input text. The system, in accordance with the present disclosure comprises a generator 10 configured to generate an initial training set. The initial training set generated by the generator 10 comprises a plurality of words. The generator 10 further associates sentiments (for example, happiness, sadness, satisfaction, dissatisfaction and the like) with each of the generated words. The generator 10 is communicably coupled to a repository 12 which stores each of the words generated by the generator 10, and the corresponding sentiments conveyed or pointed to, by each of the words. Typically, the repository 12 stores an interlinked set of a plurality of words and the corresponding sentiments.

In accordance with the present disclosure, the system 100 further includes a rule based classifier 14 configured to receive an input text, the text (typically, a group of words) whose sentiment is to be analyzed, from the user. The rule based classifier 14 segregates the received input text into a plurality of (meaningful) words. Further, the rule based classifier 14 divides each of the words into respective tokens using the tokenizer module 14A. Further, the rule based classifier 14 comprises a slang handling module 14B configured to remove any slang words from the input text, prior to the input text being fed to the tokenizer module. For example, if the input text comprises a slang word ‘LOL’, the slang handling module 14B expands the slang word ‘LOL’ as ‘Laugh Out Loud’ in order to provide for an accurate analyses of the input text, since the word ‘LOL’ would not typically be included in the repository 12, given that ‘LOL’ is a slang. The rule based classifier 14 further comprises a punctuation handling module 14C for correcting punctuations and a spelling checking module 14D for analyzing and selectively correcting the spellings in the input text.

In accordance with the present disclosure, the rule based classifier 14 processes the tokens generated by the tokenizer module 14A, and subsequently compares the words represented by the tokens with the entries in the repository 12. Further, the rule based classifier 14 selects amongst the plurality of (meaningful) words, the words that are semantically similar to the entries in the repository 10. The words (of the input text) that do not have a matching entry in the repository 12 are left unprocessed by the rule based classifier 14.

In accordance with the present disclosure, the rule based classifier 14 assigns a first score to only those words that match the entries of the repository 12, by the way of comparing each of the words (of the input) with the semantically similar entries (words) available in the repository, and associating the sentiment conveyed by the word (entry) in the repository to the corresponding semantically similar word of the input text. The rule based classifier 14 further aggregates the first score assigned to each of the plurality of words segregated from the input ext and generates an aggregated first score. The rule based classifier 14 is further configured to refine the first score assigned to each of the words of the input text, based on the syntactical connectivity between each of the words and based on the presence of negators and intensifiers in the input text.

In accordance with the present disclosure, the input text is also provided to a machine learning based classifier 16. In accordance with the present disclosure the input text can be simultaneously provided to both the rule based classifier 14 and the machine-learning based classifier 16. The machine learning based classifier 16, in accordance with the present disclosure generates a plurality of features corresponding to the input text by processing the input text, and by treating each word of the input text as one feature.

In accordance with the present disclosure, the machine learning based classifier 16 comprises a feature extraction module 16A configured to convert the input text into a plurality of n-grams of size selected from the group of sizes consisting of size 1, size 2 and size 3. Further, the feature extraction module 16A processes each of the n-grams as individual features. Further, the feature extraction module 16A is configured to process the input text and eliminate repetitive words and stop words from the input text.

In accordance with the present disclosure, the machine learning based classifier 16 implements at least one of Naïve Bayes classification model, Support Vector machines based learning model and Adaptive Logistic Regression based models to process each of the features extracted by the feature extraction module 16A. The machine learning based classifier 16 subsequently produces a second score for the input text, based on the processing of each of the features present in the input text.

In accordance with the present disclosure, the aggregated first score generated by the rule-based classifier 16 and the second score generated by the machine-learning based classifier 16 are provided to an ensemble classifier 18. The ensemble classifier 18 combines the aggregated first score generated by the rule based classifier 14 and the second score generated by the machine learning based classifier 16, and subsequently generates a classification score that denotes the sentiment conveyed by the input text. In accordance with the present disclosure, the ensemble classifier 18 is configured to compare the aggregated first score and the second score with a predetermined threshold value. The ensemble classifier 18 generates the classification score based on the input text corresponding to the aggregated first score in the event that the aggregated first score is greater than the predetermined threshold value. The ensemble classifier 18 generates the classification score based on the combination of the aggregated first score and said second score, in the event that the aggregated first score is lesser than the predetermined threshold value. The classification score, in accordance with the present disclosure is indicative of the sentiment conveyed by the input text. If the classification score is greater than a first predetermined threshold value, it pertains to a positive/happy sentiment, and if the classification score is less than the first predetermined threshold value, it pertains to a negative/unhappy/sad sentiment.

In accordance with the present disclosure, the system 100 further includes a training module 20 cooperating with the ensemble classifier 18. The training module 20 receives the input text processed by the rule based classifier 14 and the machine-learning based classifier 16, and iteratively generates training sets based on the received input text. The training sets generated by the training module 20 are typically used to modify the machine learning models stored in the machine learning based classifier 16. The training module 20 is configured to generate a training set based on the input text corresponding to the aggregated first score, in the event that the aggregated first score is greater than a second predetermined threshold value. The training module 20 is further configured to generate a training set based on the combination of input text corresponding to the aggregated first score, and the input text corresponding to the second score, in the event that the aggregated first score is lesser than the second predetermined threshold value.

In accordance with the present disclosure, the training module 20 cooperates with the machine learning based classifier 16 and selectively instructs the machine learning based classifier 16 to adapt the machine learning algorithms stored thereupon, based on the performance of said machine learning algorithms with reference to the training sets.

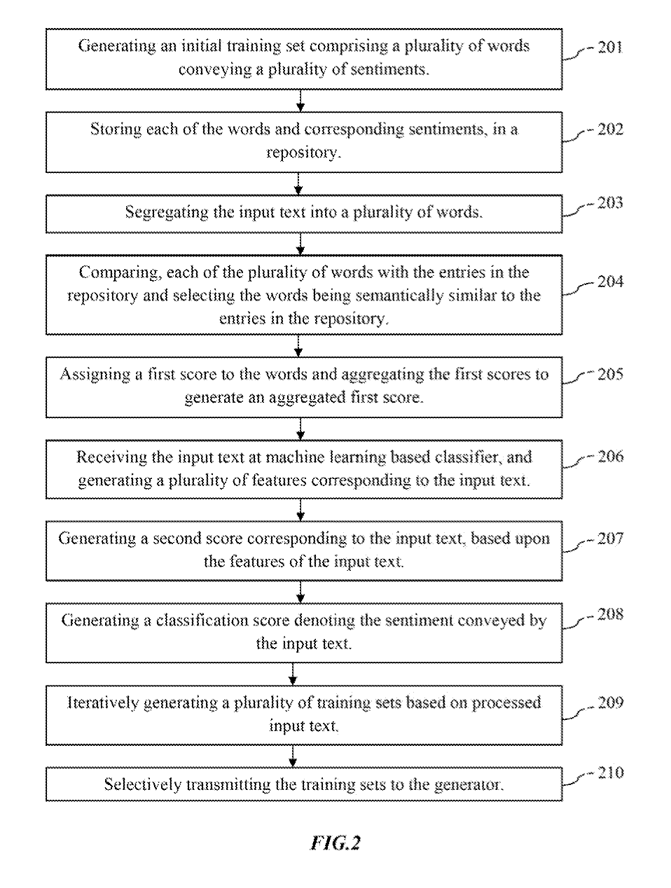

Referring to FIG. 2, there is shown a flow chart illustrating the steps involved in the computer implemented method for determining the sentiments conveyed by an input text. The method, in accordance with the present disclosure comprises the following steps: generating, using a generator, an initial training set comprising a plurality of words linked to respective sentiments (step 201); storing each of said words and corresponding sentiments, in a repository (step 202); receiving the input text at a rule based classifier and segregating the input text into a plurality of words (step 203); comparing, using the rule based classifier, each of said plurality of words with the entries in the repository and selecting amongst the plurality of words, the words being semantically similar to the entries in the repository (step 204); assigning a first score to only those words that match the entries of said repository, and aggregating the first score assigned to respective words and generating an aggregated first score (step 205); receiving the input text at a machine learning based classifier, and processing said input text using said machine learning based classifier and generating a plurality of features corresponding to the input text (step 206); generating, using said machine learning based classifier, a second score corresponding to the input text, based upon the features of the input text (step 207); combining the aggregated first score generated by the rule based classifier and the second score generated by the machine learning based classifier, and generating a classification score denoting the sentiment conveyed by the input text (step 208); receiving the input text processed by said rule based classifier and said machine-learning based classifier, at a training module, and iteratively generating a plurality of training sets based on processed input text (step 209); and selectively transmitting said training sets to the generator (step 210).

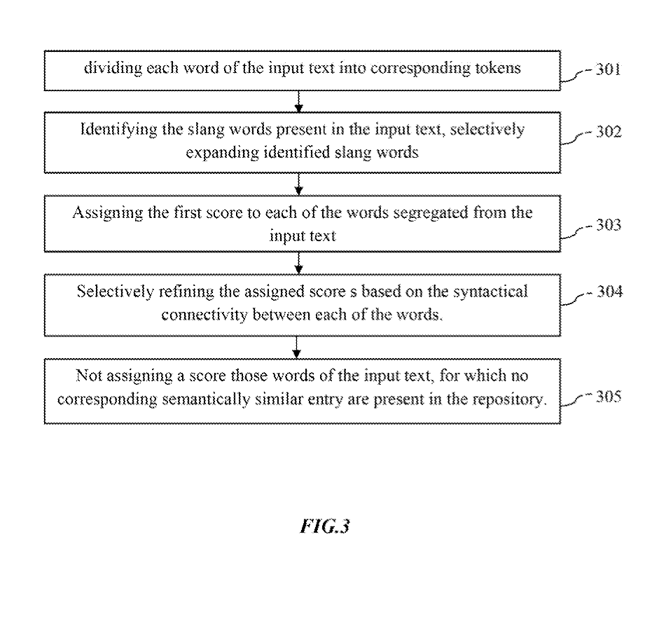

In accordance with the present disclosure, FIG. 3 describes the routine for segregating the input text into a plurality of words, for use in the computer implemented method illustrated by FIG. 2. The routine illustrated by FIG. 3 includes the following steps: dividing each word of the input text into corresponding tokens (step 301); identifying the slang words present in the input text, using a slang words handling module, and selectively expanding identified slang words thereby rendering the slang words meaningful (step 302); assigning the first score to each of the words segregated from the input text (step 303); selectively refining the score assigned to each of said words based on the syntactical connectivity between each of said words and a plurality of negators and intensifiers (step 304); and not assigning a score to those words of the input text, for which no corresponding semantically similar entry are present in said repository (step 305).

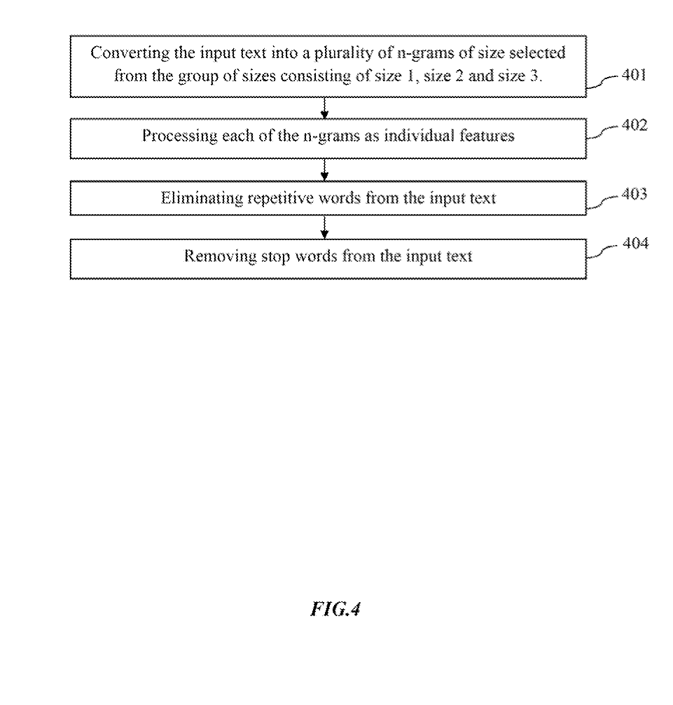

In accordance with the present disclosure, FIG. 4 describes the routine for receiving the input text at a machine learning based classifier and processing the input text using said machine learning based classifier, for use in the computer implemented method illustrated by FIG. 2. The routine described by FIG. 4 includes the following steps: converting the input text into a plurality of n-grams of size selected from the group of sizes consisting of size 1, size 2 and size 3 (step 401), processing each of the n-grams as individual features (step 402); and eliminating repetitive words from the input text (step 403), and removing stop words from the input text (step 404).

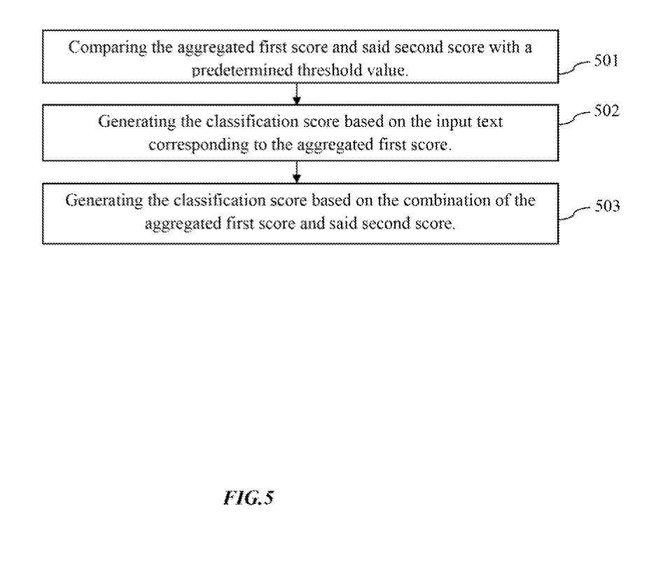

In accordance with the present disclosure, FIG. 5 describes the routine for generating a classification score denoting the sentiment conveyed by the input text for use in the computer implemented method illustrated by FIG. 2. The routine described by FIG. 5 includes the following steps: comparing, using an ensemble classifier, said aggregated first score and said second score with a predetermined threshold value (step 501); generating the classification score based on the input text corresponding to the aggregated first score, in the event that the aggregated first score is greater than the predetermined threshold value (step 502); and generating the classification score based on the combination of the aggregated first score and said second score, in the event that the aggregated first score is lesser than the predetermined threshold value (step 503).

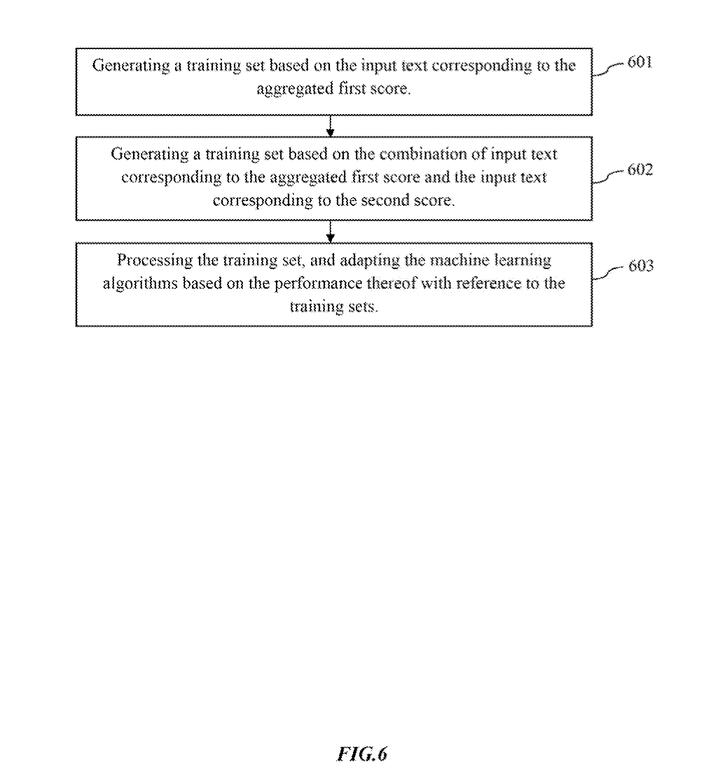

In accordance with the present disclosure, FIG. 6 describes the routine for iteratively generating a plurality of training sets based on said input text, for use in the computer implemented method illustrated by FIG. 2. The routine described by FIG. 6 includes the following steps: generating a training set based on the input text corresponding to the aggregated first score, in the event that the aggregated first score is greater than a second predetermined threshold value (step 601); generating a training set based on the combination of input text corresponding to the aggregated first score and the input text corresponding to the second score, in the event that the aggregated first score is lesser than a second predetermined threshold value (step 602); and selectively processing the training set, and instructing said machine learning based classifier to selectively adapt the machine learning algorithms stored thereupon, based on the performance of said machine learning algorithms with reference to the training sets (step 603).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications.

Although the embodiments herein are described with various specific features, it will be obvious for a person skilled in the an to practice the embodiments with modifications.

### Technical Advantages

The present disclosure envisages a system and method for determining the sentiment conveyed by an input text. The system envisaged by the present disclosure incorporates an ensemble of classification models which are rendered capable of self learning. The said ensemble includes two different norms of the classification models, one of the models is a rule based classifier model and the other model is a machine learning based classifier model. The rule-based classifier needs a set of dictionaries to initiate data processing, and the machine-learning based classifier requires sufficient amount of data to create a classification model. The present disclosure creates an ensemble of the rule-based classifier model and machine-learning-based classifier model to provide for an accurate determination of the sentiment conveyed by the input text.

The system envisaged by the present disclosure is a self-learning and hence self-improving system

The system envisaged by the present disclosure does not require a voluminous initial training set for Machine learning since the self-learning system provides a constant feedback in respect of the processed text/data.

The Rule based classifier also evolves itself by consuming a training set. The Rule based classifier refines the score, and automatically identifies and refines the threshold value for classification based on the training sets.

The system envisaged by the present disclosure incorporates the flexibility to determine different verities of sentiments and at different scales as per user requirements (e.g. Positive and Negative sentiment OR Bullish and Bearish sentiment OR Euphoric, Happy, Neutral, Sad and Depressed sentiment).

The system envisaged by the present disclosure identifies the conveyed sentiments irrespective of the level of text granularity i.e. at a word level, sentence level, paragraph level and document level.

The self-learning system of the present disclosure is language independent. Even the languages written in different scripts (for example, Hindi comments written in English script) can be appropriately classified by using an appropriate dictionary and training set.

We claim:

1. A computer implemented self learning system for analyzing the sentiments conveyed by an input text, said system comprising:
a generator configured to generate an initial training set, said initial training set comprising a plurality of words, wherein each of said words are linked to a corresponding sentiment;
a repository communicably coupled to said generator, and configured to store each of said words and corresponding sentiments;
a rule based classifier cooperating with said generator and said repository, said rule based classifier configured to receive the input text and segregate the input text into a plurality of words, said rule based classifier still further configured to compare each of said plurality of words with the entries in the repository and select amongst the plurality of words, the words being semantically similar to the entries in the repository, said rule based classifier still further configured to assign a first score to only those words that match the entries of said repository, said rule based classifier further configured to aggregate the first score assigned to respective words and generate an aggregated first score;
a machine-learning based classifier cooperating with said generator and said repository, said machine learning based classifier configured to receive the input text and process said input text, said machine learning based classifier further configured to generate a plurality of features corresponding to the input text based on the processing of the input text, and generate a second score corresponding to the input text, by processing the features thereof;
an ensemble classifier configured to combine the aggregated first score generated by the rule based classifier and the second score generated by the machine learning based classifier, said ensemble classifier further configured to generate a classification score denoting the sentiment conveyed by the input text; and
a training module cooperating with said ensemble classifier, said training module further configured to receive the input text processed by said rule based classifier and said machine-learning based classifier respectively, said training module further configured to iteratively generate training sets based on processed input text and output said training sets to the generator.

2. The system as claimed in claim 1, wherein said rule based classifier further comprises a tokenizer module configured to divide each word of the input text into corresponding tokens.

3. The system as claimed in claim 1, wherein said rule based classifier further comprises slang words handling module, said slang words handling module configured to identify the slang words present in the input text, said slang words handling module further configured to selectively expand identified slang words thereby rendering the slang words meaningful.

4. The system as claimed in claim 1, wherein said rule based classifier is further configured to assign the first score to each of the words segregated from the input text, said rule based classifier further configured to refine the score assigned to each of said words based on the syntactical connectivity between each of said words and a plurality of negators and intensifiers.

5. The system as claimed in claim 1, wherein said rule based classifier is configured not to assign a score to the words of the input text, for which no corresponding semantically similar entry are present in said repository.

6. The system as claimed in claim 1, wherein said machine learning based classifier further comprises a feature extraction module configured to convert the input text into a plurality of n-grams of size selected from the group of sizes consisting of size 1, size 2 and size 3, said feature extraction module further configured to process each of the n-grams as individual features.

7. The system as claimed in claim 6, wherein said feature extraction module is further configured to process the input text and eliminate repetitive words from the input text, said feature extraction module further configured to process and remove stop words from the input text.

8. The system as claimed in claim 1, wherein said ensemble classifier is further configured to compare said aggregated first score and said second score with a predetermined threshold value, said ensemble classifier further configured to generate the classification score based on the input text corresponding to the aggregated first score, in the event that the aggregated first score is greater than the predetermined threshold value, said ensemble classifier further configured to generate the classification score based on the combination of the aggregated first score and said second score, in the event that the aggregated first score is lesser than the predetermined threshold value.

9. The system as claimed in claim 1, wherein said training module is configured to generate a training set based on the input text corresponding to the aggregated first score, in the event that the aggregated first score is greater than a second predetermined threshold value, said training module further configured to generate a training set based on the combination of input text corresponding to the aggregated first score and the input text corresponding to the second score, in the event that the aggregated first score is lesser than the second predetermined threshold value.

10. The system as claimed in claim 9, wherein the training module cooperates with the machine learning based classifier to selectively process the training set, said training module further configured to instruct said machine learning based classifier to selectively adapt the machine learning algorithms stored thereupon, based on the performance of said machine learning algorithms with reference to the training sets.

11. A computer implemented method for determining the sentiments conveyed by an input text, said method comprising the following steps:
generating, using a generator, an initial training set comprising a plurality of words linked to respective sentiments;
storing each of said words and corresponding sentiments, in a repository;
receiving the input text at a rule based classifier and segregating the input text into a plurality of words;
comparing, using the rule based classifier, each of said plurality of words with the entries in the repository and selecting amongst the plurality of words, the words being semantically similar to the entries in the repository;
assigning a first score to only those words that match the entries of said repository, and aggregating the first score assigned to respective words and generating an aggregated first score;
receiving the input text at a machine learning based classifier, and processing said input text using said machine learning based classifier and generating a plurality of features corresponding to the input text;
generating, using said machine learning based classifier, a second score corresponding to the input text, based upon the features of the input text;
combining the aggregated first score generated by the rule based classifier and the second score generated by the machine learning based classifier, and generating a classification score denoting the sentiment conveyed by the input text;
receiving the input text processed by said rule based classifier and said machine-learning based classifier, at a training module, and iteratively generating a plurality of training sets based on processed input text; and
selectively transmitting said training sets to the generator.

12. The method as claimed in claim 11, wherein the step of segregating the input text into a plurality of words further includes the following steps:
dividing each word of the input text into corresponding tokens;
identifying the slang words present in the input text, using a slang words handling module, and selectively expanding identified slang words thereby rendering the slang words meaningful;
assigning the first score to each of the words segregated from the input text; and
selectively refining the score assigned to each of said words based on the syntactical connectivity between each of said words and a plurality of negators and intensifiers; and
not assigning a score to those words of the input text, for which no corresponding semantically similar entry are present in said repository.

13. The method as claimed in claim 11, wherein the step of receiving the input text at a machine learning based classifier, and processing said input text using said machine learning based classifier, further includes the following steps:
converting the input text into a plurality of n-grams of size selected from the group of sizes consisting of size 1, size 2 and size 3, and processing each of the n-grams as individual features;
eliminating repetitive words from the input text, and removing stop words from the input text.

14. The method as claimed in claim 11, wherein the step of generating a classification score denoting the sentiment conveyed by the input text, further includes the steps:
comparing, using an ensemble classifier, said aggregated first score and said second score with a predetermined threshold value;
generating the classification score based on the input text corresponding to the aggregated first score, in the event that the aggregated first score is greater than the predetermined threshold value; and
generating the classification score based on the combination of the aggregated first score and said second score, in the event that the aggregated first score is lesser than the predetermined threshold value.

15. The method as claimed in claim 11, wherein the step of iteratively generating a plurality of training sets based on said input text, further includes the following steps:
generating a training set based on the input text corresponding to the aggregated first score, in the event that the aggregated first score is greater than a second predetermined threshold value;
generating a training set based on the combination of input text corresponding to the aggregated first score and the input text corresponding to the second score, in the event that the aggregated first score is lesser than a second predetermined threshold value; and
selectively processing the training set, and instructing said machine learning based classifier to selectively adapt the machine learning algorithms stored thereupon, based on the performance of said machine learning algorithms with reference to the training sets.
